(19) United States
(12) Patent Application Publication
(10) Pub. No.: US 2009/0254470 A1
(43) Pub. Date: Oct. 8, 2009

(54) METHOD AND SYSTEM FOR SHARING SEARCHES

(75) Inventors: Huaping Gu, Shanghai (CN); Neelakantan Sandaresan, Mountain View, CA (US)

Correspondence Address: SCHWEGMAN, LUNDBERG & WOESSNER/EBAY, P.O. BOX 2938, MINNEAPOLIS, MN, 55402, US

(73) Assignee: Ebay Inc., San Jose, CA (US)

(21) Appl. No.: 12/061,448

(22) Filed: Apr. 2, 2008

(51) Int. Cl. G06F 7/06; G06F 17/30; G06Q 30/00

(52) U.S. Cl. 705/37; 707/3; 705/35; 707/E17.014

(57) ABSTRACT

Methods and system for sharing searches are described. In one embodiment, one or more search terms of a search request may be stored. The storage of the one or more search terms may be associated with an originating user. A sharing request may be received for the search request. The sharing request may be associated with a requesting user. The search request may be associated with the requesting user.

### BACKGROUND

Users seeking to find information available on a publication system may perform on a search of data repositories of such a system. The results of the search may be based on not only the available information but also the quality of the user's search. A poor quality search may result in not receiving desired search result or receiving too many undesirable search results.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIGS. 2 and 3 are block diagrams of example searching subsystems that may be deployed within the system of FIG. 1 according to an example embodiment;

FIGS. 4 and 5 are block diagrams of example user processing subsystems that may be deployed within the system of FIG. 1 according to an example embodiment;

FIG. 6 is an example flowchart illustrating a method for search request association according to an example embodiment;

FIG. 7 is an example flowchart illustrating a method for search processing according to an example embodiment;

FIG. 8 is an example flowchart illustrating a method for list providing according to an example embodiment;

FIG. 9 is an example flowchart illustrating a method for search request association according to an example embodiment;

FIG. 10 is an example flowchart illustrating a method for conducting a search according to an example embodiment;

FIG. 11 is an example flowchart illustrating a method for search request providing according to an example embodiment;

FIG. 12 is a network diagram depicting a network system, according to one embodiment, having a client server architecture configured for exchanging data over a network;

FIG. 13 is a block diagram illustrating an example embodiment of multiple network and marketplace applications, which are provided as part of the network-based marketplace; and

FIG. 14 is a block diagram diagrammatic representation of machine in the example form of a computer system within which a set of instructions for causing the machine to perform any one or more of the methodologies discussed herein may be executed.

### DETAILED DESCRIPTION

Example methods and systems for sharing searches are described. In the following description, for purposes of explanation, numerous specific details are set forth in order to provide a thorough understanding of example embodiments. It will be evident, however, to one skilled in the art that the present invention may be practiced without these specific details.

In an example embodiment, one or more search terms of a search request may be stored. The storing of the one or more search terms may be associated with an originating user. A sharing request may be received for the search request. The sharing request may be associated with a requesting user. The search request may be associated with the requesting user.

In an example embodiment, a search request may be received from a requesting user. The search request may include one or more search terms. The search request may be associated with an originating user. The search request may be run. A result of the running of the search request may be provided to the requesting user. A credit may be provided to the originating user based on the providing of the result.

In an example embodiment, a search request including one or more search terms may be received from an originating user. The search request and identification of the origination user may be stored. The search request and the identification of the originating user may be provided to a provider. A result of the search request may be received from the provider.

In an example embodiment, a search request including one or more search terms may be provided to a provider. A result of the search request may be received from the provider. The search request may be provided for association to an additional user. A notification regarding use of the search request by the additional user may be received. A usage credit based on the use of the search request may be received.

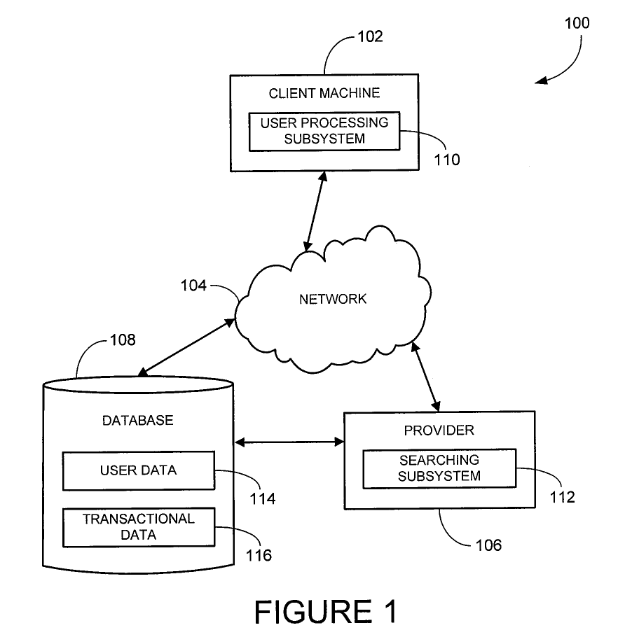

FIG. 1 illustrates an example system 100 in which a client machine 102 may be in communication with a provider 106 over a network 104. A user operating the client machine 102 may communicate with the provider 106 to conduct a search. Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

A user processing subsystem 110 may be deployed within the client machine 102 to enable a user of the client machine 102 to send and/or receive a search request with other users. For example, an originating user may provide a search request to a receiving user. The receiving user may be utilized the search request to receive search results.

The provider 106 may include a searching subsystem 112 to process search requests for one or more users (e.g., the originating user and/or the receiving user). The provider 106 may also be in communication with a database 108. The database 108 may include user data 114 and/or transactional data 116. The user data 114 may include information regarding users of the provider. The transactional data 116 may include information regarding transactions conducted by the provider 106. For example, the sale of an item from one user to another may be stored in the transactional data 116.

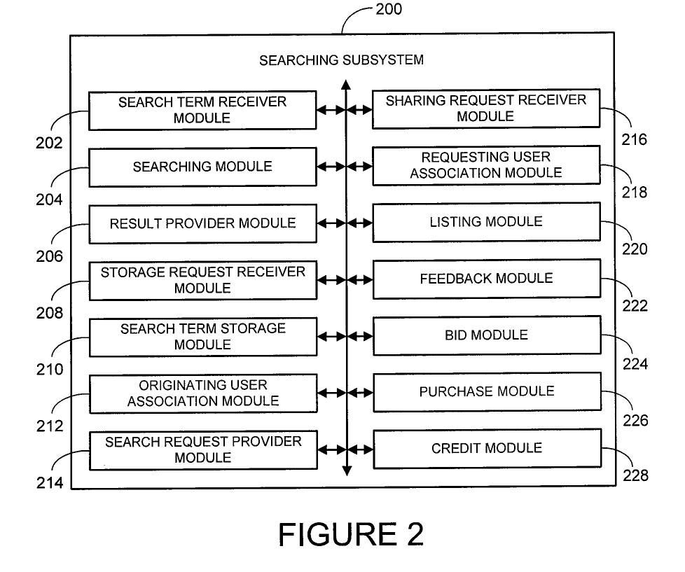

FIG. 2 illustrates an example searching subsystem 200 that may be deployed in the provider 106 of the system 100 (see FIG. 1) or otherwise deployed in another system.

The searching subsystem 200 may include a search term receiver module 202, a searching module 204, a result provider module 206, a storage request receiver module 208, a search term storage module 210, an originating user association module 212, a search request provider module 214, a sharing request receiver module 216, a requesting user association module 218, a listing module 220, a feedback module 222, a bid module 224, a purchase module 226, and/or a credit module 228. Other modules may also be included.

The search term receiver module 202 receives one or more search terms for a search request and/or one or more different search terms for a different search request. The searching module 204 runs the search request and/or runs a different search request for the requesting user.

The result provider module 206 provides a result of the running of the search and/or a different result of the running of the different search request to the requesting user for presentation.

The storage request receiver module 208 receives a storage request for the search request. The search term storage module 210 records one or more search terms of a search request. The storing of the one or more search terms may be based on the receiving of the storing request.

The originating user association module 212 associates the storing of the one or more search terms with an originating user. The search request provider module 214 provides the search request for presentation (e.g., to the requesting user on the client machine 102).

The sharing request receiver module 216 receives a sharing request for the search request. The sharing request may be associated with a requesting user. The receiving of the sharing request may be responsive to the providing of the search request.

The requesting user association module 218 associates the search request with the requesting user responsive to with the receiving of the sharing request.

The listing module 220 records an additional search request association of the search request and/or provides a listing of a number of search request associations. The number of the search request associations may include the additional search request association.

The feedback module 222 receives user feedback on the result from the requesting user and provides the search feedback on the search request for presentation. The search feedback includes the user feedback from the requesting user and/or other feedback from different users.

The bid module 224 receives a bid from the requesting user and/or processes the bid. The bid may include an item associated with the result of the search.

The purchase module 226 receives a purchase offer from the requesting user and processes the purchase offer. The purchase offer may include an item associated with the result of the search.

The credit module 228 provides search performance credit to the originating user responsive to the providing of the results, provides bid credit to the originating user responsive to the processing of the bid, provides purchase credit to the originating user responsive to the processing of the purchase offer, and/or provides origination credit to the originating user responsive to the associating of the search request with the requesting user.

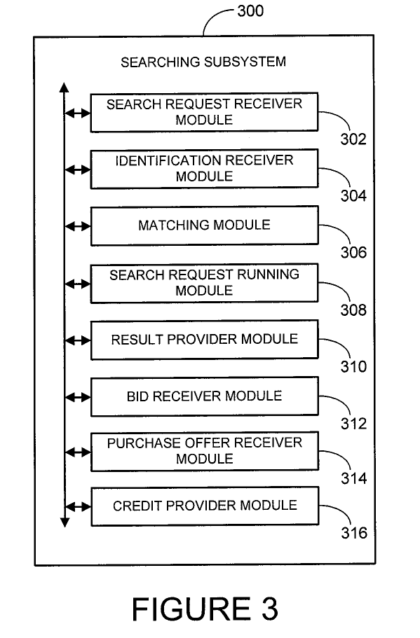

FIG. 3 illustrates an example searching subsystem 300 that may be deployed in the provider 106 of the system 100 (see FIG. 1) or otherwise deployed in another system.

The searching subsystem 300 may include a search request receiver 302, an identification receiver module 304, a matching module 306, a search request running module 308, a result provider module 310, a bid receiver module 312, a purchase offer receiver module 314, and/or a credit provider module 316.

The search request receiver 302 module receives a search request from a requesting user. The search request may include one or more search terms. The search request may be associated with an originating user.

The identification receiver module 304 receives identification of the originating user from the requesting user. The matching module 306 matches the search request with the originating user.

The search request running module 308 runs the search request. The result provider module 310 provides a result of the running of the search request to the requesting user.

The bid receiver module 312 receives a bid from the requesting user responsive to the providing of the result and/or processes a bid for an item.

The purchase offer receiver module 314 receives a purchase offer from the requesting user responsive to the providing of the result and/or processes a purchase of an item.

The credit provider module 316 provides a credit to the originating user responsive to the providing of the result. The providing of the credit to the originating user may be responsive to the providing of the result, the processing of the bid, and/or the processing of the purchase.

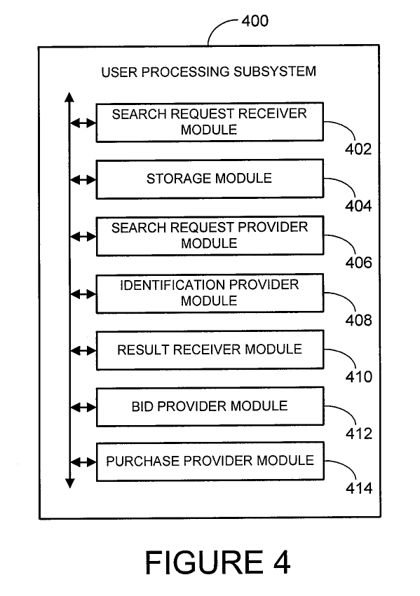

FIG. 4 illustrates an example user processing subsystem 400 that may be deployed in the client machine 102 of the system 100 (see FIG. 1) or otherwise deployed in another system.

The user processing subsystem 400 may include a search request receiver module 402, a storage module 404, a search request provider module 406, an identification provider module 408, a result receiver module 410, a bid provider module 412, and/or a purchase provider module 414. Other modules may also be included.

The search request receiver module 402 receives a search request including one or more search terms from an originating user. The storage module 404 records the search request and/or identification of the origination user.

The search request provider module 406 provides the search request and/or the identification of the originating user to the provider 106. The identification provider module 408 provides the search request and/or the identification of the originating user to the provider 106.

The result receiver module 410 receives a result of the search request from the provider 106. The bid provider module 412 provides a bid for an item in the result. The purchase provider module 414 provides a purchase offer for an item in the result.

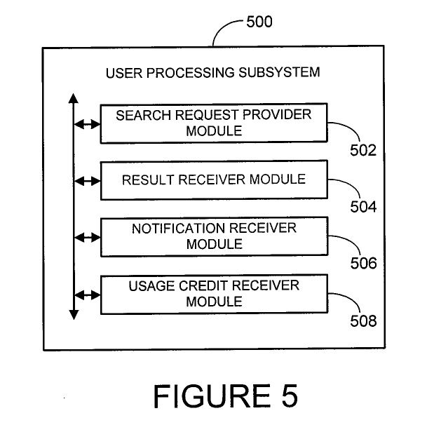

FIG. 5 illustrates an example user processing subsystem 500 that may be deployed in the client machine 102 of the system 100 (see FIG. 1) or otherwise deployed in another system.

The user processing subsystem 500 may include a search request provider module 502, a result receiver module 504, a notification receiver module 506, and/or a usage credit receiver module 508. Other modules may also be included.

The search request provider module 502 provides a search request including one or more search terms to the provider 106 and/or for association to an additional user.

The result receiver module 504 receives a result of the search request from the provider. The notification receiver module 506 receives a notification regarding use of the search request by the additional user. The usage credit receiver module 508 receives a usage credit responsive to the use of the search request.

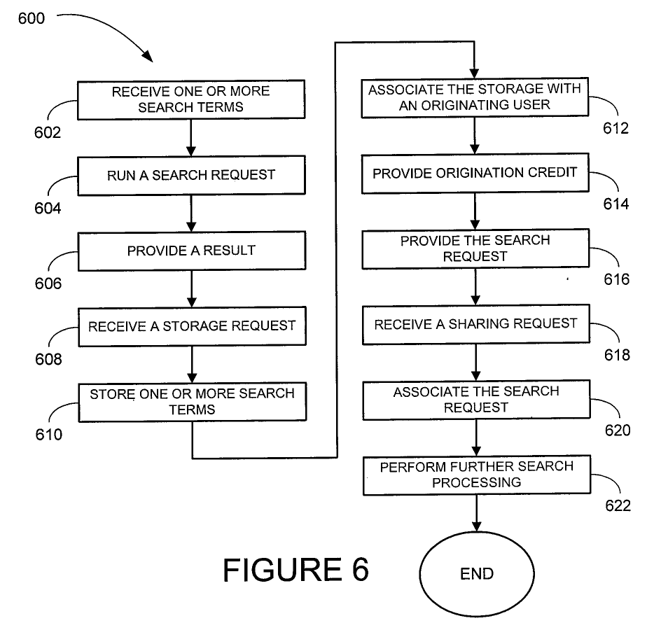

FIG. 6 illustrates a method 600 for search request association according to an example embodiment. The method 600 may be performed by the provider 106 of the system 100 (see FIG. 1) or otherwise performed.

One or more search terms may be received at block 602. The search terms may be received from an originating user. The search terms may include, by way of example, generic words, trademarked words, company names, nicknames, abbreviations, and the like. Other type of search terms may also be used.

A search request may be run using the one or more search terms at block 604. For example, the search may be run the transactional data 116 (see FIG. 1) to identify items (e.g., goods or services) listed for sale at a fixed price and/or variable price, against information listings, and/or an images collection. The search may alternatively be run against other sources of information.

A result of the running of the search may be provided for presentation to the originating user at block 606. The result may be provided on a display of the client machine 102 or may be otherwise provided.

A storage request for the search request may be received at block 608.

One or more search terms of a search request are stored at block 610. The storage may be made based on the receipt of the storage request. The storage of the one or more search terms is associated with an originating user at block 612. The association of the search terms with the origination user may enable tracking of the source of the search request. The origination user may then be provided with credit (e.g., dollars, points, etc.) based on one or more actions taken by the requesting user with respect to the search request.

Origination credit may be provided to the originating user responsive to the association of the search request with the requesting user at block 614.

The search request may be provided to the requesting user for presentation at block 616. In an example embodiment, the search request may be provided to the requesting user after receiving one or more different search terms for a different search request, running a different search request for the requesting user responsive to the receiving of the one or more search terms, and providing a different result of the running of the different search request for presentation to the requesting user.

A sharing request is received (e.g., from a requesting user) for the search request at block 618. At block 620, the search request is associated with the requesting user responsive to the receiving of the sharing request. Further search processing may be performed at block 622.

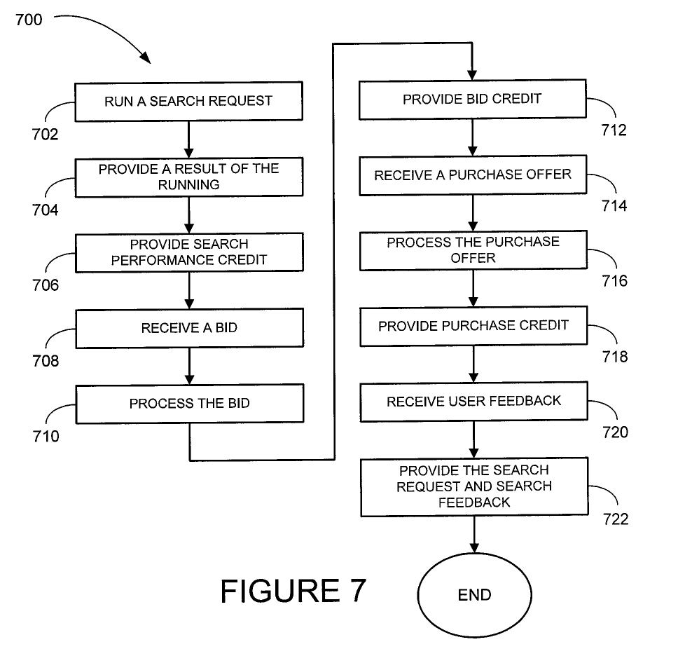

FIG. 7 illustrates a method 700 for search processing according to an example embodiment. The method 700 may be performed at block 622 (see FIG. 6) or otherwise performed.

The search request is run at block 702. The search request may be run against the transactional data 116 in the database 108 or may be otherwise run. A result of the running of the search is provided to the requesting user for presentation at block 704.

At block 706, search performance credit may be provided to the originating user responsive to the providing of the results.

A bid may be received from the requesting user at block 708. The bid may include an item associated with the result of the search. The bid may be processed at block 710. Bid credit may be provided to the originating user responsive to the processing of the bid at block 712.

A purchase offer may be received from the requesting user at block 714. The purchase offer may include an item associated with the result of the search. The purchase offer may be processed at block 716. Purchase credit may be provided to the originating user responsive to the processing of the purchase offer at block 718.

User feedback on the result may be received from the requesting user at block 720. The user feedback may include positive feedback, negative feedback, comments, or the like.

The search request and search feedback on the search request may be provided for presentation at block 722. The search feedback may include the user feedback.

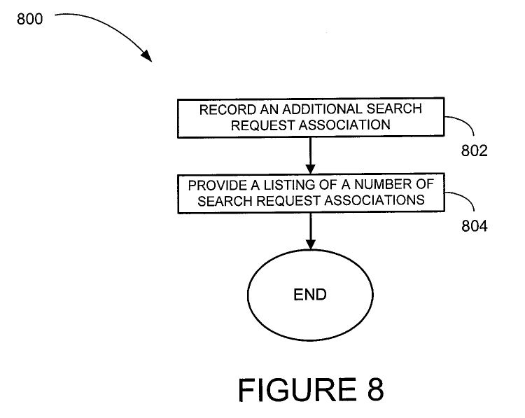

FIG. 8 illustrates a method 800 for list providing according to an example embodiment. The method 700 may be performed at block 622 (see FIG. 6) or otherwise performed.

An additional search request association of the search request is stored at block 802. A listing of a number of search request associations may be provided at block 804. The number of the search request associations may include the additional search request association. The listing may include a ranking based on the number of search request associations. Examples of rankings that may be provided include the top search requests for a category of items (e.g., antique silver), the top search requests for all items, and the like.

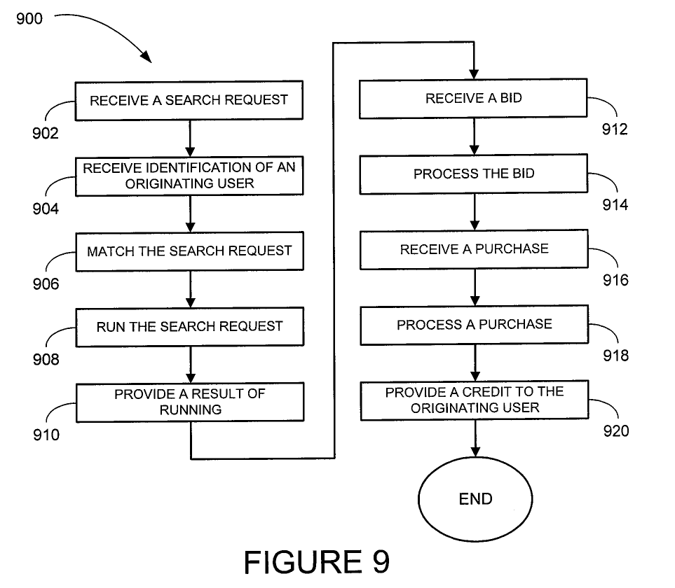

FIG. 9 illustrates a method 900 for search request association according to an example embodiment. The method 900 may be performed by the provider 106 of the system 100 (see FIG. 1) or otherwise performed.

A search request is received from a requesting user at block 902. The search request may include one or more search terms. The search request may be associated with an originating user.

Identification of the originating user may be received from the requesting user at block 904. The search request may be matched with the originating user at block 906.

The search request is run at block 908. A result of the running of the search request is provided to the requesting user at block 910.

A bid may be received from the requesting user responsive to the providing of the result at block 912. A bid for an item may be processed responsive to the receiving of the bid at block 914.

A purchase offer may be received from the requesting user responsive to the providing of the result at block 916. A purchase of an item may be processed responsive to the receiving of the purchase offer at block 918.

A credit is provided to the originating user responsive to the providing of the result at block 920. The credit may be provided to the originating user responsive to the providing of the result, the processing of the bid, and/or the processing of the purchase.

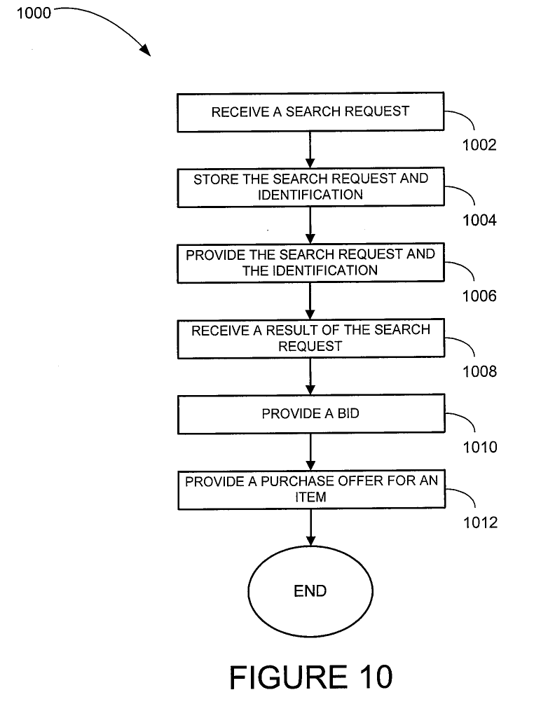

FIG. 10 illustrates a method 1000 for conducting a search according to an example embodiment. The method 1000 may be performed by the client machine 102 of the system 100 (see FIG. 1) or otherwise performed.

A search request including one or more search terms is received from an originating user at block 1002. The search request and identification of the origination user is stored at block 1004.

The search request and the identification of the originating user are provided to the provider 106 at block 1006. A result of the search request is received from the provider 106 at block 1008.

A bid may be provided for an item in the result at block 1010. A purchase offer for an item in the result may be provided at block 1012.

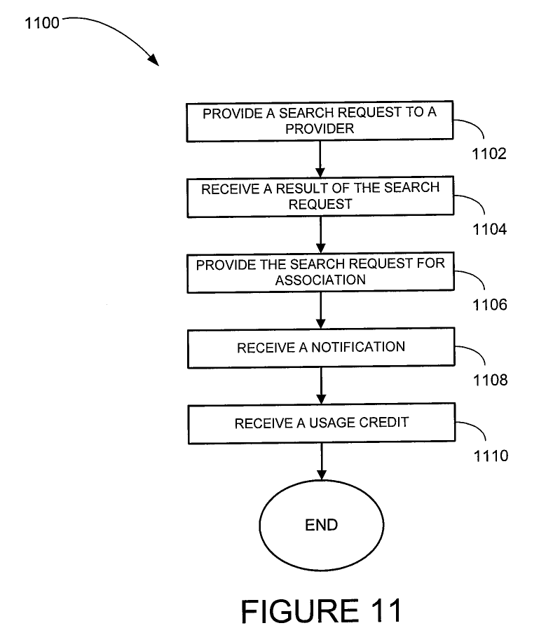

FIG. 11 illustrates a method 1100 for search request providing according to an example embodiment. The method 1100 may be performed by the client machine 102 of the system 100 (see FIG. 1) or otherwise performed.

A search request including one or more search terms is provided to the provider 106 at block 1102. A result of the search request is received from the provider 106 at block 1104.

The search request is provided for association to an additional user at block 1106. A notification regarding use of the search request is received by the additional user at block 1108. A usage credit is received responsive to the use of the search request at block 1110.

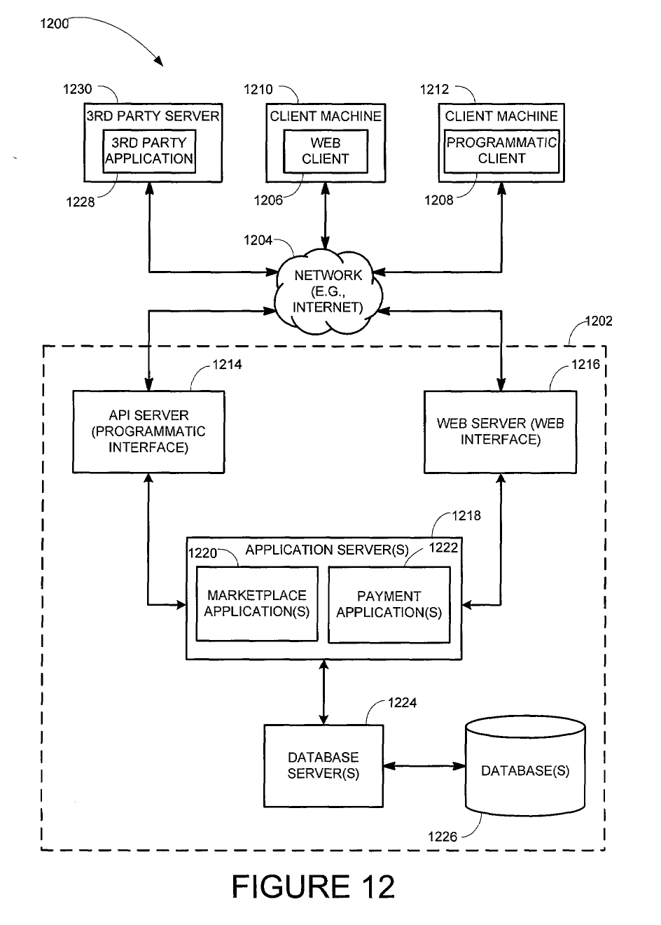

FIG. 12 is a network diagram depicting a client-server system 1200, within which one example embodiment may be deployed. By way of example, a network 1204 may include the functionality of the network 104, the provider 106 may be deployed within an application server 1218, and the client machine 102 may include the functionality of a client machine 1210 or a client machine 1212. The system 100 may also be deployed in other systems.

A networked system 1202, in the example forms of a network-based marketplace or publication system, provides server-side functionality, via a network 1204 (e.g., the Internet or Wide Area Network (WAN)) to one or more clients. FIG. 12 illustrates, for example, a web client 1206 (e.g., a browser, such as the Internet Explorer browser developed by Microsoft Corporation of Redmond, Wash. State), and a programmatic client 1208 executing on respective client machines 1210 and 1212.

An Application Program Interface (API) server 1214 and a web server 1216 are coupled to, and provide programmatic and web interfaces respectively to, one or more application servers 1218. The application servers 1218 host one or more marketplace applications 1220 and authentication providers 1222. The application servers 1218 are, in turn, shown to be coupled to one or more databases servers 1224 that facilitate access to one or more databases 1226.

The marketplace applications 1220 may provide a number of marketplace functions and services to users that access the networked system 1202. The authentication providers 1222 may likewise provide a number of payment services and functions to users. The authentication providers 1222 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1220. While the marketplace and authentication providers 1220 and 1222 are shown in FIG. 12 to both form part of the networked system 1202, in alternative embodiments the authentication providers 1222 may form part of a payment service that is separate and distinct from the networked system 1202.

Further, while the system 1200 shown in FIG. 12 employs a client-server architecture, the present invention is of course not limited to such an architecture, and could equally well find application in a distributed, or peer-to-peer, architecture system, for example. The various marketplace and authentication providers 1220 and 1222 could also be implemented as standalone software programs, which need not have networking capabilities.

The web client 1206 accesses the various marketplace and authentication providers 1220 and 1222 via the web interface supported by the web server 1216. Similarly, the programmatic client 1208 accesses the various services and functions provided by the marketplace and authentication providers 1220 and 1222 via the programmatic interface provided by the API server 1214. The programmatic client 1208 may, for example, be a seller application (e.g., the TurboLister™ application developed by eBay Inc., of San Jose, Calif.) to enable sellers to author and manage listings on the networked system 1202 in an off-line manner, and to perform batch-mode communications between the programmatic client 1208 and the networked system 1202.

FIG. 12 also illustrates a third party application 1228, executing on a third party server machine 1230, as having programmatic access to the networked system 1202 via the programmatic interface provided by the API server 1214. For example, the third party application 1228 may, utilizing information retrieved from the networked system 1202, support one or more features or functions on a website hosted by the third party. The third party may, for example, provide one or more promotional, marketplace or payment functions that are supported by the relevant applications of the networked system 1202.

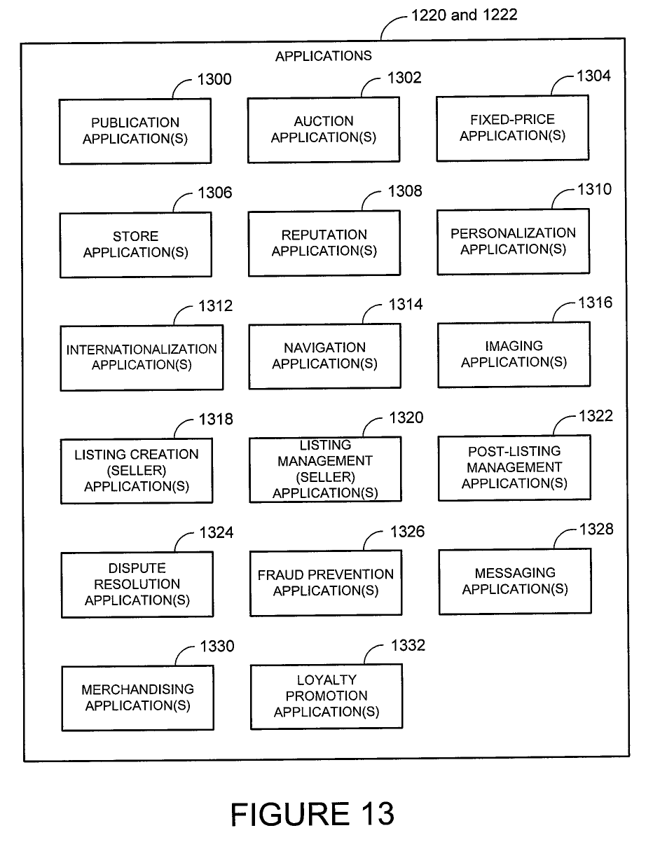

FIG. 13 is a block diagram illustrating multiple applications 1220 and 1222 that, in one example embodiment, are provided as part of the networked system 1202 (see FIG. 12). The applications 1220 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 1226 via the database servers 1224.

The networked system 1202 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 1220 are shown to include at least one publication application 1300 and one or more auction applications 1302 which support auction-format listing and price setting mechanisms (e.g., English, Dutch, Vickrey, Chinese, Double, Reverse auctions etc.). The various auction applications 1302 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1304 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1306 allow a seller to group listings within a “virtual” store, which may be branded and otherwise personalized by and for the seller. Such a virtual store may also offer promotions, incentives and features that are specific and personalized to a relevant seller.

Reputation applications 1308 allow users that transact, utilizing the networked system 1202, to establish, build and maintain reputations, which may be made available and published to potential trading partners. Consider that where, for example, the networked system 1202 supports person-to-person trading, users may otherwise have no history or other reference information whereby the trustworthiness and credibility of potential trading partners may be assessed. The reputation applications 1308 allow a user, for example through feedback provided by other transaction partners, to establish a reputation within the networked system 1202 over time. Other potential trading partners may then reference such a reputation for the purposes of assessing credibility and trustworthiness.

Personalization applications 1310 allow users of the networked system 1202 to personalize various aspects of their interactions with the networked system 1202. For example a user may, utilizing an appropriate personalization application 1310, create a personalized reference page at which information regarding transactions to which the user is (or has been) a party may be viewed. Further, a personalization application 1310 may enable a user to personalize listings and other aspects of their interactions with the networked system 1202 and other parties.

The networked system 1202 may support a number of marketplaces that are customized, for example, for specific geographic regions. A version of the networked system 1202 may be customized for the United Kingdom, whereas another version of the networked system 1202 may be customized for the United States. Each of these versions may operate as an independent marketplace, or may be customized (or internationalized and/or localized) presentations of a common underlying marketplace. The networked system 1202 may accordingly include a number of internationalization applications 1312 that customize information (and/or the presentation of information) by the networked system 1202 according to predetermined criteria (e.g., geographic, demographic or marketplace criteria). For example, the internationalization applications 1312 may be used to support the customization of information for a number of regional websites that are operated by the networked system 1202 and that are accessible via respective web servers 1216.

Navigation of the networked system 1202 may be facilitated by one or more navigation applications 1314. For example, a search application (as an example of a navigation application) may enable key word searches of listings published via the networked system 1202. A browse application may allow users to browse various category, catalogue, or system inventory structures according to which listings may be classified within the networked system 1202. Various other navigation applications may be provided to supplement the search and browsing applications. In an example embodiment, the user processing subsystem 110 and/or the searching subsystem 112 (see FIG. 1) may include the functionality of the navigation applications 1314.

In order to make listings available via the networked system 1202 as visually informing and attractive as possible, the marketplace applications 1220 may include one or more imaging applications 1316 utilizing which users may upload images for inclusion within listings. An imaging application 1316 also operates to incorporate images within viewed listings. The imaging applications 1316 may also support one or more promotional features, such as image galleries that are presented to potential buyers. For example, sellers may pay an additional fee to have an image included within a gallery of images for promoted items.

Listing creation applications 1318 allow sellers conveniently to author listings pertaining to goods or services that they wish to transact via the networked system 1202, and listing management applications 1320 allow sellers to manage such listings. Specifically, where a particular seller has authored and/or published a large number of listings, the management of such listings may present a challenge. The listing management applications 1320 provide a number of features (e.g., auto-relisting, inventory level monitors, etc.) to assist the seller in managing such listings. One or more post-listing management applications 1322 also assist sellers with a number of activities that typically occur post-listing. For example, upon completion of an auction facilitated by one or more auction applications 1202, a seller may wish to leave feedback regarding a particular buyer. To this end, a post-listing management application 1322 may provide an interface to one or more reputation applications 1308, so as to allow the seller conveniently to provide feedback regarding multiple buyers to the reputation applications 1308.

Dispute resolution applications 1314 provide mechanisms whereby disputes arising between transacting parties may be resolved. For example, the dispute resolution applications 1314 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 1326 implement fraud detection and prevention mechanisms to reduce the occurrence of fraud within the networked system 1202.

Messaging applications 1328 are responsible for the generation and delivery of messages to users of the networked system 1202, such messages for example advising users regarding the status of listings at the networked system 1202 (e.g., providing “outbid” notices to bidders during an auction process or to provide promotional and merchandising information to users). Respective messaging applications 1328 may utilize any one have a number of message delivery networks and platforms to deliver messages to users. For example, messaging applications 1328 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1330 support various merchandising functions that are made available to sellers to enable sellers to increase sales via the networked system 1202. The merchandising applications 1330 also operate the various merchandising features that may be invoked by sellers, and may monitor and track the success of merchandising strategies employed by sellers.

The networked system 1202 itself, or one or more parties that transact via the networked system 1202, may operate loyalty programs that are supported by one or more loyalty/promotions applications 1332. For example, a buyer may earn loyalty or promotions points for each transaction established and/or concluded with a particular seller, and may be offered a reward for which accumulated loyalty points can be redeemed.

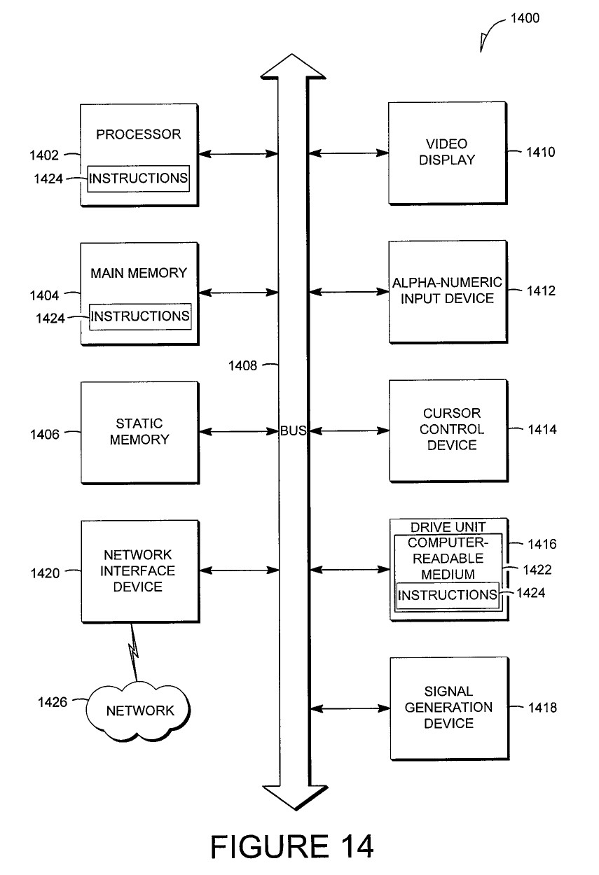

FIG. 14 shows a diagrammatic representation of machine in the example form of a computer system 1400 within which a set of instructions may be executed causing the machine to perform any one or more of the methods, processes, operations, or methodologies discussed herein. The provider 106 may operate on or more computer systems 1400. The client machine 102 may include the functionality of one or more computer systems 1400.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU) a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a cursor control device 1414 (e.g., a mouse), a drive unit 1416, a signal generation device 1418 (e.g., a speaker) and a network interface device 1420.

The drive unit 1416 includes a machine-readable medium 1422 on which is stored one or more sets of instructions (e.g., software 1424) embodying any one or more of the methodologies or functions described herein. The software 1424 may also reside, completely or at least partially, within the main memory 1404 and/or within the processor 1402 during execution thereof by the computer system 1400, the main memory 1404 and the processor 1402 also constituting machine-readable media.

The software 1424 may further be transmitted or received over a network 1426 via the network interface device 1420.

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for sharing searches have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
storing one or more search terms of a search request;
associating the storing of the one or more search terms with an originating user;
receiving a sharing request for the search request, the sharing request associated with a requesting user; and
associating the search request with the requesting user.

2. The method of claim 1, further comprising:
running the search request; and
providing a result of the running of the search request to the requesting user.

3. The method of claim 2, further comprising:
providing search performance credit to the originating user responsive to the providing of the results.

4. The method of claim 2, further comprising:
receiving a bid from the requesting user, the bid including an item associated with the result of the search;
processing the bid; and
providing bid credit to the originating user responsive to the processing of the request.

5. The method of claim 2, further comprising:
receiving a purchase offer from the requesting user, the purchase offer including an item associated with the result of the search; and
providing a purchase credit to the originating user for origination of the purchase offer.

6. The method of claim 2, further comprising:
receiving user feedback on the result from the requesting user; and
providing the search request and search feedback on the search request for presentation, the search feedback including the user feedback.

7. The method of claim 1, further comprising:
providing the search request to the requesting user for presentation,
wherein the receiving of the sharing request is responsive to the providing of the search request.

8. The method of claim 7, further comprising:
receiving one or more different search terms for a different search request;
running a different search request for the requesting user responsive to the receiving of the one or more search terms; and
providing a different result of the running of the different search request for presentation to the requesting user.

9. The method of claim 1, further comprising:
storing an additional search request association of the search request; and
providing a listing of a number of search request associations, the number of the search request associations including the additional search request association.

10. The method of claim 1, further comprising:
providing origination credit to the originating user responsive to the associating of the search request with the requesting user.

11. The method of claim 1, further comprising:
receiving one or more search terms;
running the search request for the originating user using the one or more search terms; and
providing a result of the search for presentation to the originating user,
wherein the storing of the one or more search terms is responsive to the running of the search.

12. The method of claim 1, further comprising:
receiving a storage request for the search request;
wherein the storing of the one or more search terms is responsive to the receiving of the storing request.

13. A method comprising:
receiving a search request from a requesting user, the search request including one or more search terms, and being associated with an originating user;
running the search request;
providing a result of the search request to the requesting user; and
providing a credit to the originating user based on the providing of the result.

14. The method of claim 13, wherein the receiving of the search request comprises:
receiving an identification of the originating user and the search request from the requesting user.

15. The method of claim 13, further comprising:
matching the search request with the originating user.

16. The method of claim 13, further comprising:
receiving a purchase offer from the requesting user responsive to the providing of the result; and
processing a purchase of an item responsive to the receiving of the purchase offer,
wherein the providing of the credit to the originating user is based on the providing of the result and the processing of the purchase.

17. The method of claim 13, further comprising:
receiving a bid from the requesting user responsive to the providing of the result; and
processing a bid for an item responsive to the receiving of the bid;
wherein the providing of the credit to the originating user is based on the providing of the result and the processing of the bid.

18. A machine-readable medium comprising instructions, which when implemented by one or more processors perform the following operations:
record one or more search terms of a search request;
associate the storing of the one or more search terms with an originating user;
receive a sharing request for the search request, the sharing request associated with a requesting user; and
associate the search request with the requesting user.

19. The machine-readable medium of claim 18 further comprising instructions, which when implemented by one or more processors perform the following operations:
run the search request; and
provide a result of the running of the search to the requesting user.

20. The machine-readable medium of claim 19 further comprising instructions, which when implemented by one or more processors perform the following operations:
receive a bid from the requesting user, the bid including an item associated with the result of the search;
process the bid; and
provide bid credit to the originating user responsive to the processing of the bid.

21. A machine-readable medium comprising instructions, which when implemented by one or more processors perform the following operations:
receive a search request from a requesting user, the search request including one or more search terms, the search request being associated with an originating user;
run the search request;
provide a result of the running of the search request to the requesting user; and
provide a credit to the originating user responsive to the providing of the result.

22. The machine-readable medium of claim 21 further comprising instructions, which when implemented by one or more processors perform the following operations:
match the search request with the originating user.

23. A system comprising:
a search term storage module to store one or more search terms of a search request;
an originating user association module to associate storage of the one or more search terms by the search term storage module with an originating user;
a sharing request receiver module to receive a sharing request for the search request, the sharing request associated with a requesting user; and
a requesting user association module to associate the search request with the requesting user responsive to the receiving of the sharing request by the sharing request receiver module.

24. The system of claim 23, further comprising:
a searching module to run the search request; and
a result provider module to provide a result of the running of the search by the searching module to the requesting user for presentation.

25. The system of claim 23, further comprising:
a purchase module to receive a purchase offer from the requesting user, the purchase offer including an item associated with the result of the search, processing the purchase offer, and provide purchase credit to the originating user responsive to the processing of the purchase offer.
